(19) United States
(12) Patent Application Publication
(10) Pub. No.: US 2003/0019617 A1
(43) Pub. Date: Jan. 30, 2003

(54) Device for suspension of heating elements

(76) Inventor: Frank Hoffmeister, Hamburg (DE)

Correspondence Address: HARNESS, DICKEY & PIERCE, P.L.C., P.O. BOX 828, BLOOMFIELD HILLS, MI, 48303, US

(21) Appl. No.: 10/158,485

(22) Filed: May 30, 2002

(30) Foreign Application Priority Data
May 31, 2001 (DE) 101 26 467.4

(51) Int. Cl. F26B 11/02; D06F 58/00; F28D 7/00; F28F 9/00

(52) U.S. Cl. 165/162; 34/108

(57) ABSTRACT

The device serves to suspend heating elements in the interior of a receptacle drum of a drier. The drier is provided with a rotary drive for the drum, and the heating elements exhibit a tubular conformation. The heating elements are guided in a support comprising a basic element and a clamping element positionable relative to the basic element. Both the basic element and the clamping element are provided with guidance recesses for the heating elements. The heating elements extend through the guidance recesses. The clamping element is arranged adjustable in a radial direction with respect to the longitudinal axis of the drum.

### BACKGROUND AND SUMMARY OF THE INVENTION

The invention relates to a device for suspension of heating elements in the interior of a receptacle drum of a drier equipped with a rotary drive for the drum, where the heating elements exhibit a tubular conformation.

Such driers are employed for example to remove a proportion of water, in whole or at least in part, from moist material. Upon rotation of the drum, forces act on the heating elements, and may lead to a loosening of the elements in the suspension means used. The resulting relative motions between the heating elements and the suspension elements, in simultaneous presence of the goods to be dried, lead to occurrence of wear effects on the heating elements. An especially rapid appearance of manifestations of wear may be observed if the heating elements are set comparatively loosely in the suspension elements at original installation, and the goods to be dried can enter into the resulting gaps. Goods entering into such gaps will also lead to occurrence of frictional and abrasive effects.

The object of the present invention is to design a device of the kind initially mentioned in such manner that relative motions between the heating elements and the suspensions of the heating elements are diminished.

This object is accomplished, according to the invention, in that the heating elements are guided in a support comprising a basic element and a clamping element positionable relative to the basic element, in that both the basic element and the clamping element are provided with guidance recesses for the heating elements, through which the heating elements extend, and in that the clamping element is arranged adjustable in a radial direction with respect to a longitudinal axis of the drum.

By the passage of the heating elements both through guidance recesses of the support and through guidance recesses of the clamping element, it is possible, in event of a displacement of the clamping element relative to the basic element, to provide an overlap of the respective guidance recesses only to such an extent that the heating elements are clamped in. The radial arrangement of the clamping element supports both a displacement of the heating elements that assists a drying operation and ensures good accessibility when the clamping operation is performed.

A typical application consists in that the receptacle drum is configured as part of a steam drier.

In particular, it is considered that the receptacle drum may be configured as part of a drier for granular material.

A special field of application is opened up in that the receptacle drum is configured as part of a drier for copper ore concentrate.

For effective supply of a flowable heating medium, it is proposed that the heating elements be configured at least locally as heating tubes.

As a design measure to accomplish the positionability of the clamping element, it is proposed that the clamping element be connected with a positioning element.

A simple and sturdy embodiment is achieved in that the positioning element is of bolt-like configuration.

A high stability and at the same time convenient operability may be achieved in that the basic element is rigidly fixed relative to the receptacle drum and in that the positioning element protrudes at least locally from the receptacle drum.

To ensure retention of a preassigned positioning, provision is made for the positioning element to be braceable relative to an outside wall of the receptacle drum.

A load-supporting suspension of the heating elements, together with simplicity of installation, is achieved in that at least one of the guidance recesses exhibits a U-shaped conformation.

The retention of preassigned movements may be supported in that the clamping element is guided relative to the basic element.

To enhance the clamping effect, it is proposed that a spacing element extend between the basic element and the clamping element.

A conservative clamping of the heating elements is supported in that at least one deformable compensating element is arranged in the neighborhood of at least one of the guidance recesses.

In particular, consideration is given to configuration of the compensating element in an elastomeric or thermoplastic material.

To allow for the temperatures prevailing, it is proposed that the compensating element be made of Teflon.

An economical fabrication and simple assembly is assisted in that the compensating element be at least locally of pencil-like configuration.

A retention of a preassigned clamped positioning is also assisted in that the positioning element is tensed relative to the receptacle drum by at least one spring.

To ensure robust service properties, special consideration is given to configuring the spring as at least one cup spring.

In the drawings, embodiments of the invention are schematically represented by way of example, in which:

### BRIEF DESCRIPTION OF THE DRAWINGS

FIG. 1 shows a cross section of the receptacle drum of a drier, comprising tubular elements essentially extending axially, which may be connected circular-segment fashion and are segmentally arranged concentrically relative to each other;

FIG. 2 shows an enlarged representation of heating elements suspended by a basic element and a clamping element;

FIG. 3 shows a top view of a clamping element;

FIG. 4 shows a side view as seen in direction IV in FIG. 3;

FIG. 5 shows an enlarged representation of detail V in FIG. 3;

FIG. 6 shows an enlargement of detail VI in FIG. 1;

FIG. 7 shows an enlarged representation of a clamping element with inserted compensating element before clamping;

FIG. 8 shows a representation according to FIG. 7 following a deformation of the compensating element due to a clamping operation; and

FIG. 9 shows a cross section at the line IX-IX in FIG. 1 with heating elements removed.

### DETAILED DESCRIPTION OF THE PREFERRED EMBODIMENT

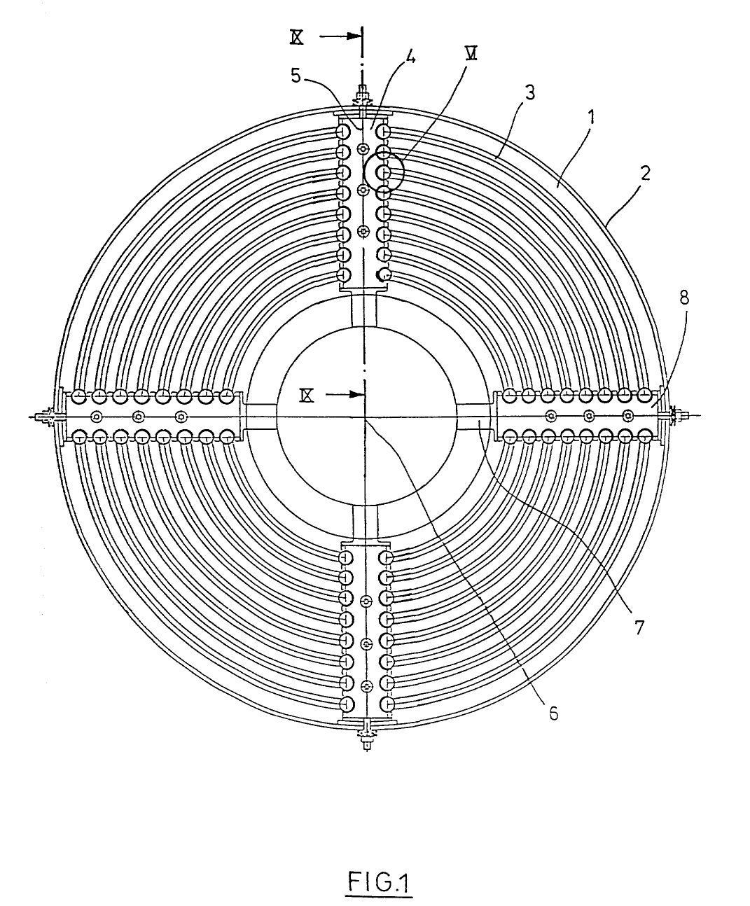

According to the embodiment of FIG. 1, in the neighborhood of an interior (1) of a receptacle drum (2) of a drier, a plurality of heating elements (3) is arranged. The heating elements (3) extend essentially in tubular fashion, with special consideration given to passing a heating medium through the tubular heating elements (3).

The heating elements (3) are suspended from supports (4) extending with lengthwise axes (5) of the supports radially with respect to a longitudinal axis (6) of the drum. The supports (4) likewise consist of a basic element (7) and a clamping element (8) guided positionably relative to the basic element (7).

In the embodiment represented in FIG. 1, the heating elements (3) extend segmentally, essentially concentric with the longitudinal drum axis (6), and the individual heating elements (3) are arranged with a spacing relative to each other in radial direction. It proves advantageous to employ four supports (4), each pair bounding a drum angle of about 90 degrees.

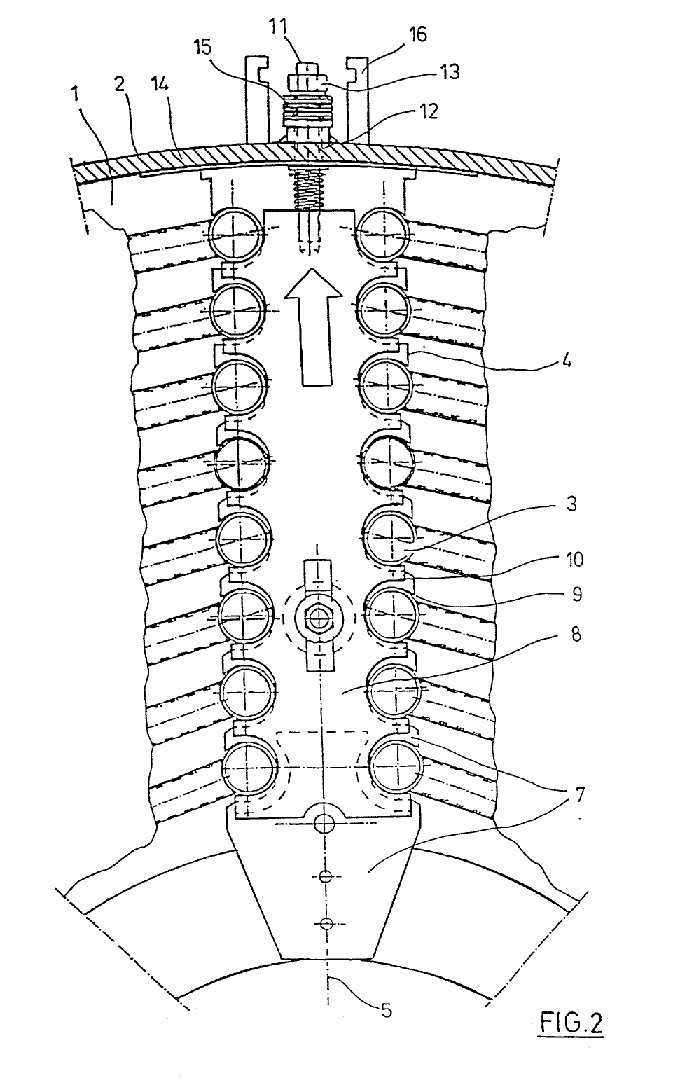

FIG. 2, in an enlarged representation, shows the arrangement of the support (4) inside the drum (2). In particular, it may be seen that the basic element (7) and the clamping element (8) are in each instance provided with guidance recesses (9, 10) through which the heating elements (3) extend. In particular, consideration is given to arranging the guidance recesses (9, 10) comb-fashion along lateral boundaries of the elements (7, 8) and providing them with an essentially U-shaped conformation. Besides, it proves advantageous, in order to support a load-bearing fixation of the heating elements (3), to provide at least some of the guidance recesses (9) with a centerline tangential to the radial direction of the receptacle drum (2) and additional guidance recesses (9, 10) with orientation directed oblique to the radial direction. In the embodiment according to FIG. 2, the guidance recesses (9) are provided in the neighborhood of the basic element with the centerlines extending oblique to the radial direction, and the guidance recesses (10) of the clamping element (8) with the tangential orientation of the centerlines.

The basic element (7) is rigidly fixed relative to the receptacle drum (2). To support a radial adjustability of the clamping element (8), the clamping element (8) comprises a positioning element (11), preferably accessible outside of the receptacle drum (2). In the embodiment shown, the positioning element (11) is configured as a threaded bolt, protruding through a recess (12) of the drum (2) and fixable with a nut (13). Specifically, consideration is given to arranging a tensible compression spring between the nut (13) and an outer wall (14) of the drum (2), configured for example as a cup spring or a pack of cup springs. In case of repairs, the nut (13) is freed and a stirrup having a puller screw is inserted laterally into the suspensions (16). If fixedly seated, the positioning element (11) can be freed in this way.

In the embodiment shown, the heating elements (3) consist of segments extending essentially concentric to the longitudinal axis (6) of the drum, and adjacent segments extending essentially in the direction of the longitudinal drum axis (6). The segments pass one into another by means of suitable bends in the heating elements (3). The guidance recesses (9, 10) are so positioned that the segments of the heating elements (3) that extend in the direction of the longitudinal axis (6) of the drum extend through the guidance recesses (9, 10). By a relative motion in radial direction between the clamping element (8) and the basic element (7), the heating elements (3) can thus be clamped in.

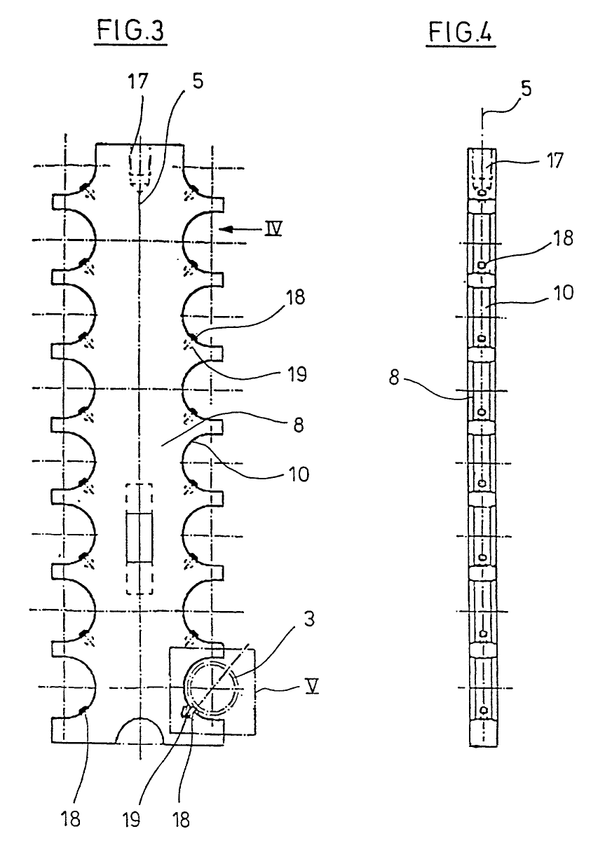

FIG. 3 shows the clamping element (8) with an associated heating element (3). It may be seen that the clamping element (8) is provided with an internal thread (17) into which a bolt-like positioning element (11) can be screwed. Besides, in the neighborhood of the guidance recesses (10), compensating elements (18) are arranged, which may be made of an elastomeric or thermoplastic material. In particular, consideration is given to a pencil-like design of the compensating elements (18), and to inserting them into suspension holes (19) of the clamping element (8). A positioning of the compensating elements (18) takes place in the case of the embodiment according to FIG. 3 in such manner that respective lengthwise axes are oriented obliquely to a lengthwise support axis (5). Besides, the compensating elements (18) are arranged in a neighborhood of the guidance recesses (10), which are subjected to compression when the heating elements (3) are clamped in. As material for the compensating elements (18), for example Teflon may be employed.

FIG. 4 shows a side view of the arrangement of the guidance recesses (10) in the neighborhood of the clamping element (8). Specifically also, the positioning of the compensating elements (18) is again clarified.

FIG. 5, in an enlarged representation, shows the detail V in FIG. 3. Here it may be seen in particular how part of the compensating element (18) extends into a gap between the heating element (3) and the wall of the guidance recess (10), thus effecting a tolerance compensation.

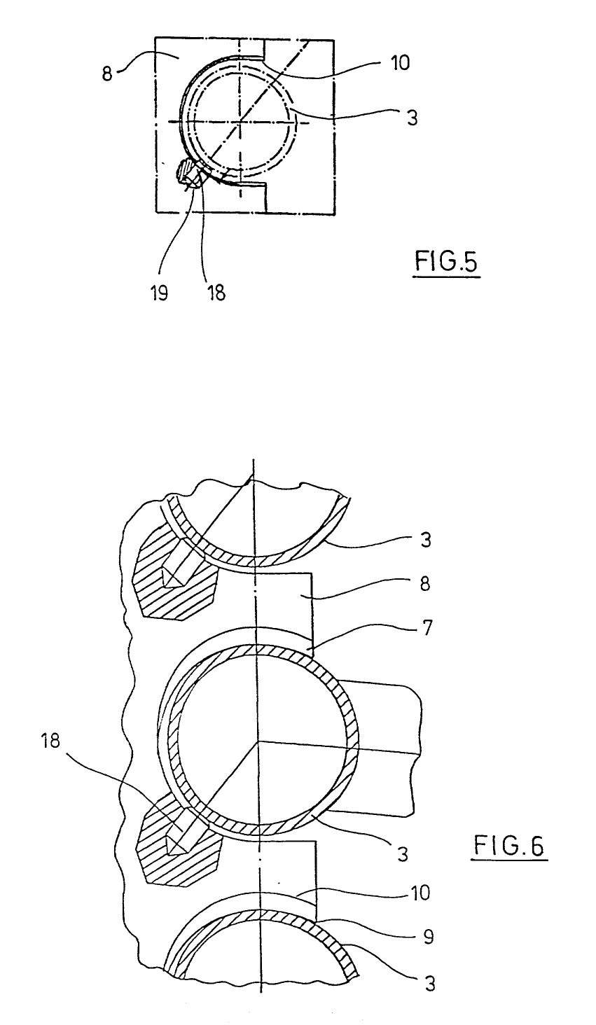

FIG. 6, much enlarged for further clarification, shows the detail VI in FIG. 1. It may be seen in particular how the two guidance recesses (9, 10) are displaced relative to each other, thus clamping the heating elements (3) in. Likewise, it may be seen how owing to the orientation of the guidance recess (9), a geometrically positive suspension of the heating elements (3) is accomplished within the support (4).

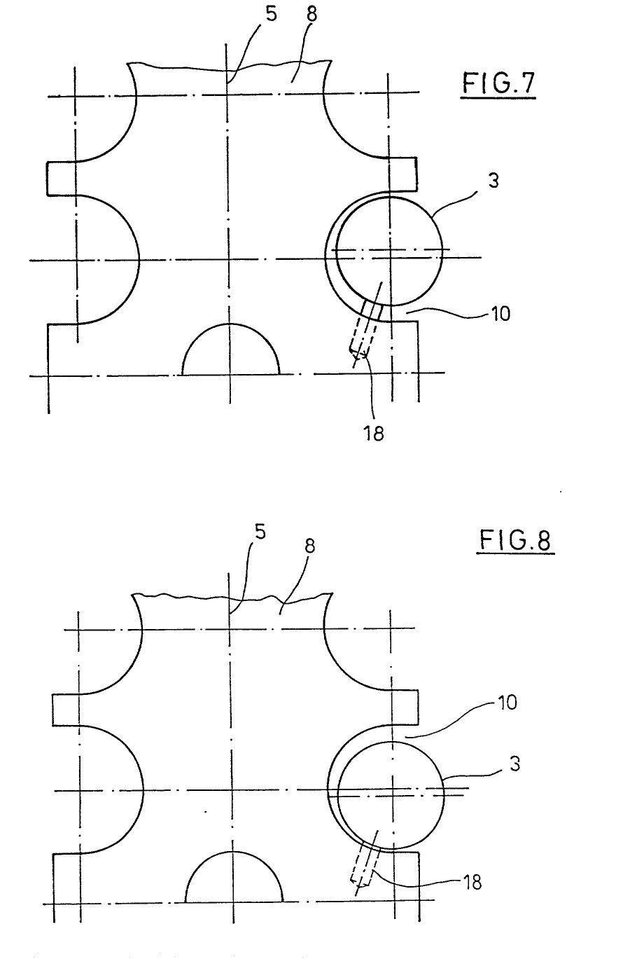

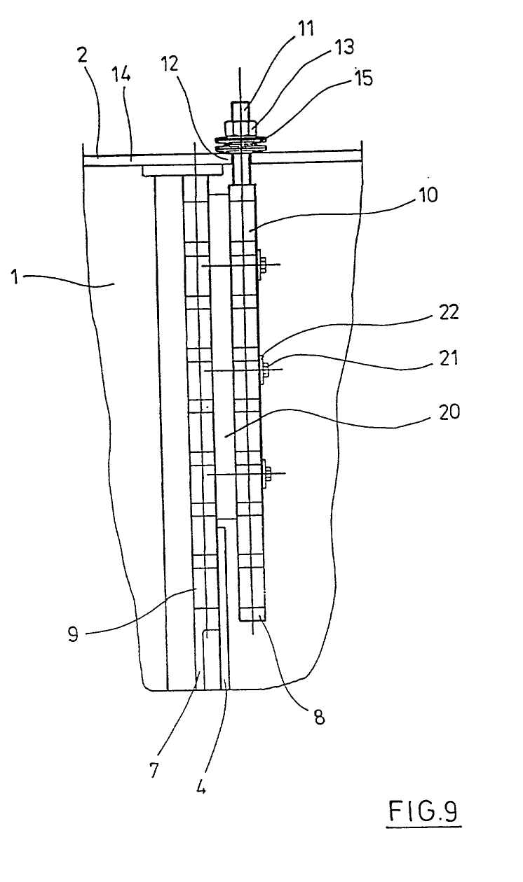

FIGS. 7 and 8 illustrate the deformation of the compensating element (18) on performance of a clamping operation. FIG. 7 shows a pencil-like compensating element (18) in a basic condition in which the compensating element (18) projects into the neighborhood of the guidance recesses (19). After the performance of the clamping operation as represented in FIG. 8, a portion of the part of the compensating element (18) protruding into the guidance recesses (9, 10) is deformed, leading both to a tolerance compensation and to a conservative clamping operation, in particular avoiding effects of edges on the heating elements (3).

Specifically, the heating elements (3) are held with nearly equal clamping force owing to the tolerance compensation.

FIG. 9 shows a side view of the coordination of the clamping element (8) relative to the basic element (7). In particular, it may be seen that the clamping element (8) is positioned with a spacing from the basic element (7). To maintain this spacing, a spacer plate (20) is arranged between the basic element (7) and the clamping element (8). The spacer plate (20) may for example be fixedly connected to the clamping element (8) and positionable jointly with the clamping element (8). Likewise, it is possible to connect the spacer plate (20) fixedly to the basic element (7), and therefore to have the clamping element (8) movable also with respect to the spacer plate (20).

To ensure a guidance of the clamping element (8) upon actuation of the positioning element (11), guide pins (21) may be employed, passing through associated guidance slots of the clamping element (8). For example, it is possible to brace heads of the guidance bolts (21) against the clamping element (8) by way of coverplates (22).

The support (4) consisting of basic element (7) and clamping element (8) is especially suitable for installation in the neighborhood of a receptacle drum (2), provided for thermal treatment of fine-grained products. From the heating elements (3), tubular rings are formed, essentially arranged concentric to the longitudinal axis (6) of the drum, and lying in the neighborhood of the material trickling down from the receptacle drum (2). The tubular heating elements (3) are traversed by steam passed from a star-shaped manifold chamber on one side of the drum into the tubular heating elements (3). The steam supply and condensate removal are conjoined in a central connecting pipe. To pick up the resulting fumes, scavenging air is aspirated through the drum (2). Specifically, consideration is given to providing comparatively low flow velocities in order to prevent dust entrainment to a large extent. The combination of the receptacle drum with the heating elements (3) constitutes a steam drier drum.

In particular, consideration is given to arranging the receptacle drum (2) rotatable relative to its longitudinal axis (6) and having the receptacle drum (2) rotate together with the heating elements (3). The mingling of the material as a result of this motion leads to a considerable improvement in drying effect. The receptacle drum (2) may for example be driven by an externally arranged ring gear cooperating with the drive gears.

I claim:

1. Device for suspension of heating elements in the interior of a receptacle drum of a drier provided with a rotary drive for the receptacle drum, where the heating elements exhibit a tubular conformation, characterized in that the heating elements (3) are guided in a support (4) comprising a basic element (7) and a clamping element (8) positionable relative to the basic element (7), in that both the basic element (7) and the clamping element (8) are provided with guidance recesses (9, 10) for the heating elements (3), through which the heating elements (3) extend, and in that the clamping element (8) is arranged adjustable in a radial direction with respect to a longitudinal axis (6) of the drum.

2. Device according to claim 1, characterized in that the receptacle drum (2) is configured as part of a steam drier.

3. Device according to claim 1, characterized in that the receptacle drum (2) is configured as part of a drier for granular material.

4. Device according to claim 1, characterized in that the receptacle drum (2) is configured as part of a drier for copper ore concentrate.

5. Device according to claim 1, characterized in that the heating elements (3), at least locally, are configured in the form of heating pipes.

6. Device according to claim 1, characterized in that the clamping element (8) is connected with a positioning element (11).

7. Device according to claim 6, characterized in that the positioning element (11) is of bolt-like configuration.

8. Device according to claim 6, characterized in that the basic element (7) is rigidly fixed relative to the receptacle drum (2) and in that the positioning element (11) at least locally protrudes from the receptacle drum (2).

9. Device according to claim 6, characterized in that the positioning element (11) is tensable relative to an outside wall (14) of the receptacle drum (2).

10. Device according to claim 1, characterized in that at least one of the guidance recesses (9, 10) exhibits a substantially U-shaped conformation.

11. Device according to claim 1, characterized in that the clamping element (8) is guided relative to the basic element (7).

12. Device according to claim 1, characterized in that a spacer element extends between the basic element (7) and the clamping element (8).

13. Device according to claim 1, characterized in that, in the neighborhood of at least one of the guidance recesses (9, 10), at least one deformable compensating element (18) is arranged.

14. Device according to claim 13, characterized in that the compensating element (18) is made of an elastomeric material.

15. Device according to claim 13, characterized in that the compensating element (18) is made of a thermoplastic material.

16. Device according to claim 13, characterized in that the compensating element (18) is made of Teflon.

17. Device according to claim 13, characterized in that the compensating element (18) is at least locally of pencil-like configuration.

18. Device according to claim 6, characterized in that the positioning element (11) is biased relative to the receptacle drum (2) by at least one spring.

19. Device according to claim 18, characterized in that the spring (15) is configured as at least one cup spring.
